(19) United States
(12) Patent Application Publication
(10) Pub. No.: US 2016/0217459 A1
(43) Pub. Date: Jul. 28, 2016

(54) SYSTEMS AND METHODS FOR SMART TOKEN ALLOCATION SCHEME

(71) Applicant: American Express Travel Related Services Company, Inc., New York, NY (US)

(72) Inventors: Stephen E. Lindner, Phoenix, AZ (US); Brett A. Mcleod, Scottsdale, AZ (US); Alois T. Stock, White Plains, NY (US)

(73) Assignee: American Express Travel Related Services Company, Inc., New York, NY (US)

(21) Appl. No.: 14/607,747

(22) Filed: Jan. 28, 2015

(51) Int. Cl. G06Q 20/36; G06Q 20/40; G06Q 20/38

(52) U.S. Cl. CPC G06Q 20/3674; G06Q 20/3821; G06Q 20/3825; G06Q 20/40145; G06Q 2220/00

(57) ABSTRACT

During token and PAN provisioning, instead of just having one token per one PAN for a single use case (PAN), between 1 and N tokens per a single PAN are provisioned. During provisioning a decision engine will supply additional details that are applied to each token. This additional information is stored in a token virtual vault that houses the mapping between PAN and token. Then, during a transaction, the decision engine chooses which token to give to the merchant to process business as usual. When the token comes into the network, additional information associated with that individual token may be identified. This information may be conveyed to a transaction account Issuer in substantially real time on and/or appended to the transactional message.

### FIELD

The present disclosure generally relates to secure transactions, and more particularly, to providing a member of a transaction (e.g., a merchant) a token rather than a primary account number.

### BACKGROUND

Tokenization, when applied to data security, is the process of substituting a sensitive data element with a non-sensitive equivalent, referred to as a token that has no extrinsic or exploitable meaning or value. The token is a reference (i.e. identifier) that maps back to the sensitive data through a tokenization system. The mapping from original data to a token uses methods which render tokens infeasible to reverse in the absence of the tokenization system, for example using tokens created from random numbers. The tokenization system must be secured and validated using security best practices applicable to sensitive data protection, secure storage, audit, authentication and authorization. The tokenization system provides data processing applications with the authority and interfaces to request tokens, or detokenize back to sensitive data.

### SUMMARY

According to various embodiments, the method includes receiving a selection of a transaction account code associated with a transaction instrument. A plurality of tokens per received single primary account number may be provisioned. Each token of the plurality of tokens is associated in a virtual vault according to a specific method of authentication to be used with a token. The encoded plurality of tokens may be transmitted to an e-wallet application for use.

According to various embodiments, the method may include encoding the plurality of tokens. The method of authentication includes at least one of a one-time code, a 3-D Secure system, or an Issuer Authentication API. The method of authentication includes at least one of a finger print, a biometric, or a retinal scan. Processing a transaction including the token is also disclosed. The method may include shifting liability for fraud from the merchant to the issuer based on use of the methods described herein. The e-wallet application may store the plurality of tokens for use based on the method of authentication available to a transaction. An audit may be performed where the type of authentication utilized in a transaction may be known from inspection of at least one of the vault or the e-wallet and/or vault or the e-wallet records.

The forgoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The features and advantages of the present disclosure will become more apparent from the detailed description set forth below when taken in conjunction with the drawings. The left-most digit of a reference number identifies the drawing in which the reference number first appears.

FIG. 1 illustrates, in accordance with various embodiments, a token provisioning process; and

FIG. 2 illustrates, in accordance with various embodiments, a token authorization process.

### DETAILED DESCRIPTION

The detailed description of exemplary embodiments herein makes reference to the accompanying drawings, which show the exemplary embodiments by way of illustration and their best mode. While these exemplary embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

Phrases and terms similar to “financial institution,” “transaction account issuer” and “payment processor” may include any person, entity, software and/or hardware that offers transaction account services. Although often referred to as a “financial institution,” the financial institution may represent any type of bank, lender or other type of account issuing institution, such as credit card companies, card sponsoring companies, or third party issuers under contract with financial institutions. It is further noted that other participants may be involved in some phases of the transaction, such as an intermediary settlement institution.

The terms “payment vehicle,” “financial transaction instrument,” “transaction instrument,” or “transaction account product” may be used interchangeably throughout to refer to a financial instrument. As used herein, an account code may or may not be associated with a physical financial instrument.

Phrases and terms similar to a “buyer,” “participant”, “consumer,” and “user” may include any person, entity, software and/or hardware that receives items in exchange for consideration (e.g. financial payment). For example, a buyer may purchase, lease, rent, barter or otherwise obtain items from a supplier and pay the supplier using a transaction account.

Phrases or terms similar to a “processor” (such as a payment processor) or “transaction account issuer” may include a company (e.g., a third party) appointed (e.g., by a merchant) to handle transactions for merchant banks Processors may be broken down into two types: front-end and back-end. Front-end processors have connections to various transaction accounts and supply authorization and settlement services to the merchant banks' merchants. Back-end processors accept settlements from front-end processors and, via The Federal Reserve Bank, move money from an issuing bank to the merchant bank. In an operation that will usually take a few seconds, the payment processor will both check the details received by forwarding the details to the respective account's issuing bank or card association for verification, and may carry out a series of anti-fraud measures against the transaction. Additional parameters, including the account's country of issue and its previous payment history, may be used to gauge the probability of the transaction being approved. In response to the payment processor receiving confirmation that the transaction account details have been verified, the information may be relayed back to the merchant, who will then complete the payment transaction. In response to the verification being denied, the payment processor relays the information to the merchant, who may then decline the transaction.

As used herein, “transmit” may include sending electronic data from one system component to another over a network connection. Additionally, as used herein, “data” may include encompassing information such as commands, queries, files, data for storage, and the like in digital or any other form.

Phrases or terms similar to “transaction account” may include any account that may be used to facilitate a financial transaction. A “transaction account” as used herein refers to an account associated with an open account or a closed account system (as described herein). The transaction account may exist in a physical or non-physical embodiment. For example, a transaction account may be distributed in non-physical embodiments such as an account number, frequent-flyer account, and telephone calling account or the like. Furthermore, a physical embodiment of a transaction account may be distributed as a financial instrument.

Tokenization (and its processes) are industry defined by the EMVCo organization. Building an alternate payments ecosystem may include a number of entities working together in order to deliver near field communication (NFC) or other technology based payment services to end users. One of the challenges is the interoperability between the players. To resolve this challenge, the role of a trusted service manager (TSM) is proposed to establish a technical link between mobile network operators (MNO) and providers of services, so that these entities can work together. Tokenization can play a role in mediating such services. The basis of tokenization is that a “token” is given to a merchant in place of a Primary Account Number (PAN) essentially becoming surrogate PANs. The smart token process described herein delivers significantly more transactional information to a Network and/or Issuer during and/or after a transaction.

In general, transaction accounts may be used for transactions between the user and merchant through any suitable communication means, such as, for example, a telephone network, intranet, the global, public Internet, a point of interaction device (e.g., a point of sale (POS) device, personal digital assistant (PDA), mobile telephone, kiosk, etc.), online communications, off-line communications, wireless communications, and/or the like.

An “account”, “account code”, or “account number”, as used herein, may include any device, code, number, letter, symbol, digital certificate, smart chip, digital signal, analog signal, biometric or other identifier/indicia suitably configured to allow the consumer to access, interact with or communicate with the system (e.g., one or more of an authorization/access code, personal identification number (PIN), Internet code, other identification code, and/or the like). The account number may optionally be located on or associated with a rewards card, charge card, credit card, debit card, prepaid card, telephone card, embossed card, smart card, magnetic stripe card, bar code card, transponder, radio frequency card or an associated account. The system may include or interface with any of the foregoing cards or devices, QR codes, Bluetooth, Near Field Communication, or a transponder and RFID reader in RF communication with the transponder (which may include a fob). Typical devices may include, for example, a key ring, tag, card, cell phone, wristwatch or any such form capable of being presented for interrogation.

Moreover, the system, computing unit or device discussed herein may include a “pervasive computing device,” which may include a traditionally non-computerized device that is embedded with a computing unit. Examples can include watches, Internet enabled kitchen appliances, restaurant tables embedded with RF readers, wallets or purses with imbedded transponders, etc.

The account code may be distributed and stored in any form of plastic, electronic, magnetic, radio frequency, wireless, audio and/or optical device capable of transmitting or downloading data from itself to a second device. A customer account code may be, for example, a sixteen-digit transaction account code, although each transaction account provider has its own numbering system, such as the fifteen-digit numbering system used by American Express. Each company's transaction account codes comply with that company's standardized format such that the company using a fifteen-digit format will generally use three-spaced sets of numbers, as represented by the number “0000 000000 00000”. The first five to seven digits are reserved for processing purposes and identify the issuing bank, card type, etc. In this example, the last (fifteenth) digit is used as a sum check for the fifteen digit number. The intermediary eight-to-eleven digits are used to uniquely identify the customer. A merchant account code may be, for example, any number or alpha-numeric characters that identify a merchant for purposes of card acceptance, account reconciliation, reporting, or the like.

It should be noted that the transfer of information in accordance with the present disclosure, may be completed in a format recognizable by a merchant system or account issuer. In that regard, by way of example, the information may be transmitted from a contactless (e.g., an RFID device) to a contactless (e.g., RFID) reader or from the contactless reader to the merchant system in a variety of formats, e.g., magnetic stripe or multi-track magnetic stripe format.

As used herein, an http session may comprise an impermanent interactive communication exchange between a first web-client (as described herein) and a second web-client and/or between a front-end system, such as a web-client (e.g., a mobile device or personal computer) and a backend system (e.g., a transaction account issuer server or server system).

A web-client may include any device (e.g., personal computing device/mobile communication device) which communicates via any network. A web-client may be associated with and/or used by a consumer, a merchant, or both. A web-client may comprise a variety of browsing software or browser applications (e.g., Microsoft Internet Explorer, Mozilla Firefox, Google Chrome, Apple Safari, or any other of the myriad software packages available for browsing the internet). Such browser applications may comprise Internet browsing software installed within a computing unit or a system to conduct online transactions and/or communications. These computing units or systems may take the form of a computer or processor, or a set of computers/processors, although other types of computing units or systems may be used, including laptops, notebooks, hand held computers, personal digital assistants, cellular phones, smart phones (e.g., iPhone®, BlackBerry®, Droid®, etc.) set-top boxes, workstations, computer-servers, main frame computers, mini-computers, PC servers, pervasive computers, network sets of computers, personal computers, such as iPads, iMACs, and MacBooks, kiosks, terminals, point of sale (POS) devices and/or terminals, televisions, or any other device capable of receiving data over a network 104.

As those skilled in the art will appreciate, a web-client may include an operating system (e.g., Windows NT, 95/98/2000/CE/Mobile, OS2, UNIX, Linux, Solaris, MacOS, PalmOS, etc.) as well as various conventional support software and drivers typically associated with computers. A web-client may implement security protocols such as Secure Sockets Layer (SSL) and Transport Layer Security (TLS). A web-client may implement one or more application layer protocols, including, for example, http, https, ftp, and sftp. Transactions originating at a web client may pass through a firewall (not shown; see below) in order to prevent unauthorized access from users of other networks.

A network may comprise any electronic communications system or method which incorporates software and/or hardware components. Communication may be accomplished through any suitable communication channels, such as, for example, a telephone network, an extranet, an intranet, Internet, point of interaction device (point of sale device, personal digital assistant, smart phone, cellular phone (e.g., iPhone®, Palm Pilot®, Blackberry®), kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although a network 104 may be described herein as being implemented with TCP/IP communications protocols, the network 104 may also be implemented using IPX, Appletalk, IP-6, NetBIOS, OSI, any tunneling protocol (e.g. IPsec, SSH), or any number of existing or future protocols. If the network 106 is in the nature of a public network, such as the Internet, it may be advantageous to presume the network 104 to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components described herein may be independently, separately or collectively coupled to the network 106 via one or more data links including, for example, a connection to an Internet Service Provider (ISP) over a local loop as is typically used in connection with standard modem communication, cable modem, Dish networks, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network 104 may be implemented variously. For example, network 104 may be implemented as an interactive television (ITV) network. The systems and methods disclosed herein contemplate the use, sale and/or distribution of any goods, services or information over any network having functionality similar to that described above with reference to network 104.

A wallet platform may comprise any type of hardware and/or software (e.g., a computer server, mobile device computer based system, or computer server system) configured or configurable to provide and/or transmit information associated with a transaction account (such as a smart token).

An electronic acquisition system may comprise any type of hardware and/or software (e.g., a computer server or computer server system) configured or configurable to approve and/or decline an application for credit and/or provide and/or transmit information associated with a transaction account (such as a smart token).

A virtual vault may be created to store the relationship between an issued token and an associated funding account and/or or PAN. Notably, the merchant does not have access to the true account number and/or or PAN. In this way, if the merchant system is compromised, a transaction account processor may know that a fraudulent transaction is occurring. For instance, a cryptogram associated with the token may include a set of transaction details. These transaction details may include domain restrictions. Domain restrictions may be any desired domain restrictions. These restrictions may include a restrictions related to which merchant is involved or restrictions associated with an industry code associated with the merchant. Domain restrictions may be associated with a physical transaction instrument transaction or an electronic only transaction.

The merchant may be notified of the breach. The issuer may be notified that the token is going to be cancelled and that the associated transaction with the compromised token should be rejected, but the card member experience is not affected.

Tokens may be one time use tokens. A one-time use token may be issued for use with a transaction at a merchant. Tokens may also be static tokens, wherein static as referred to herein may indicate that the token may be available for more than one use.

According to various embodiments, use of the smart token system may enable the liability for fraud to be shifted from the merchant to the issuer of the PAN.

According to various embodiments, a plurality of different methods of authentication associated with the smart token system may exist. For example, a first method of authentication may be a challenge with a one-time code. For instance, a one-time code is delivered to a user, (e.g., through a SMS on a mobile device) and the code can be entered into a field by a user. A one-time code may be delivered to a user via an email. A second method of authentication is 3-D Secure or the American Express™ implementation of SafeKey™. 3-D Secure is an XML-based protocol designed to be an additional security layer for online credit and debit card transactions. 3-D Secure adds an authentication step for online payments.

SafeKey™ is a method and system where a transaction processor contacts the issuer with transaction details. The transaction issuer reviews the details of the transaction and approves that the transaction details are within acceptable bounds for the user. A third method of authentication is an Issuer Authentication API. The transaction details may be more robust than the details communicated in the second method associate with the SafeKey™ system. For instance, the transaction details may include buyer browser information, buyer IP address, buyer electronic device hardware information, buyer billing address, buyer transaction instrument card information, buyer shipping information and/or the like. In this way, more information is passed to the decisioning entity (e.g., the issuer) to make a determination on the authorization of the transaction to proceed and/or to potentially allow for fraud liability shift (from the merchant to the Issuer). The transaction details may then be compared against pre-stored metrics, to determine a likelihood of fraudulent activity. In this way, the decisioning entity may make a much more informed decision.

According to various embodiments, an individual token is presented and/or transmitted to a merchant for use in a single payment transaction based on the type of authentication utilized by the merchant for a transaction. In this way, a decision engine (e.g., a device and/or software system interposed in-between the transaction account holder and the merchant) is configured to make a decision on which token to issue based on known details associated with a merchant, the transaction account holder and/or transaction environment.

According to various embodiments, an individual token is issued to the merchant based on the type of authentication method utilized by the transaction account holder for a transaction. For instance, the authentication method utilized by the transaction account holder may be a finger print, a biometric, a retinal scan and/or the like.

According to various embodiments, upon issuance of a token, additional information is associated the token in the virtual vault. “Virtual vault” as used herein may refer to a secure database. For instance, this information may include the type of authentication utilized by the merchant for transactions. This information may include the type of authentication method utilized by the transaction account holder.

During token and PAN provisioning, instead of just having one token per one PAN for a single use case PAN, between 1 and N tokens per a single PAN are provisioned. During provisioning, a decision engine will supply additional details that are applied to each token. This additional information may be stored in a token virtual vault that houses the mapping between the PAN and token. Then, during a transaction, the decision engine chooses which token to give to the merchant to process business as usual. When the token comes into the network, additional information associated with that individual token may be identified. This information may be conveyed to a transaction account issuer in substantially real time on and/or appended to the transactional message.

A digital wallet, and/or e-wallet, may refer to an electronic device that allows an individual to make electronic commerce transactions. This can include purchasing items on-line with a computer or using a smartphone to purchase something at a store. Increasingly, digital wallets are being made not just for basic financial transactions but to also authenticate the holder's credentials. For example, a digital-wallet could potentially verify the age of the buyer to the store while purchasing alcohol. It is useful to approach the term “digital wallet” not as a singular technology, but as three major parts: the system (the electronic infrastructure), the application (the software that operates on top) and the device (the individual portion).

An individual's bank account can also be linked to the digital wallet. The individual may also have their driver's license, health card, loyalty card(s), credit account, charge account, debit account, and other ID documents stored on the phone. The credentials can be passed to a merchant's terminal wirelessly via near field communication (NFC). Certain sources are speculating that these smartphone “digital wallets” will eventually replace physical wallets.

A digital wallet has both a software and information component. The software provides security and encryption for the personal information and for the actual transaction. Typically, digital wallets are stored on the client side and are easily self-maintained and fully compatible with most e-commerce Web sites. A server-side digital wallet, also known as a thin wallet, is one that an organization creates for and about you and maintains on its servers. Server-side digital wallets are gaining popularity among major retailers due to the security, efficiency, and added utility it provides to the end-user, which increases their satisfaction of their overall purchase. The information component is basically a database of user-inputted information. This information consists of your shipping address, billing address, payment methods (including credit card numbers, expiry dates, and security numbers), and other information.

Digital wallets are generally composed of both digital wallet devices and digital wallet systems. Digital wallet systems enable the widespread use of digital wallet transactions among various retail vendors in the form of mobile payments systems and digital wallet applications. According to various embodiments, in operation, an e-wallet upon registration, may contact a transaction account processor and/or keeper of the virtual vault to add a transaction instrument and associate the PAN to the e-wallet. The virtual vault may issue a variety of tokens to be utilized by the e-wallet, such as a distinct token to be utilized based on the method of authentication utilized by the merchant for a transaction. The e-wallet itself may store the issued tokens and transmit them as appropriate during a transaction. This process may be referred to as the provisioning process. In this way, a token is provisioned and the relationship to the funding account (e.g., the PAN) is established. As stated above, the relationship between the PAN and the token may be stored in the vault.

Later, upon receipt of the token associated with a transaction request, additional information may be known about the authentication process based on the token utilized.

In this way, N number of tokens may be assigned based on additional data associated with the use of the token. Stated another way, the logic engine may request information or request a token, and supply specific information to be provided at a later time, such as during a transaction. The merchant may be provided with the correct token that represents the desired information. N number of tokens may be associated to one PAN at a single device, such as an e-wallet, for concurrent use.

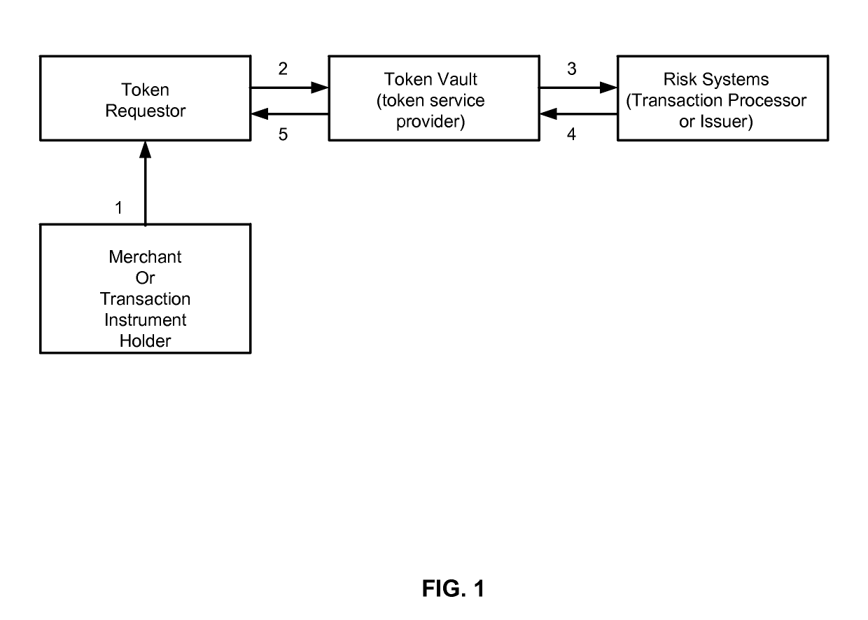

According to various embodiments and with reference to FIG. 1, the token provisioning process is described. In response to a provisioning process being enacted (Step 1), a token requestor, such as an e-wallet (e.g., Amex Express Checkout™), requests a token from a virtual vault on behalf of the merchant or on behalf of the transaction account holder (e.g., card member) (Step 2). The token requestor verifies that permissions exist to add the transaction instrument to the e-wallet (Step 3). Upon approval, the e-wallet system requests tokens associated with the transaction account associated with the transaction instrument (e.g., PAN) from the token virtual vault (Step 4). The virtual vault could be a third-party vault. The virtual vault may issue a variety of tokens to the e-wallet system based on a variety of factors associated with the single transaction instrument (Step 5). For instance, a token associated with a one-time code authentication method, a token associated with 3-D Secure, and a token associated with Issuer Authentication API is generated. These tokens and associated information may be stored in the virtual vault and delivered to the e-wallet system. The e-wallet system may store the tokens.

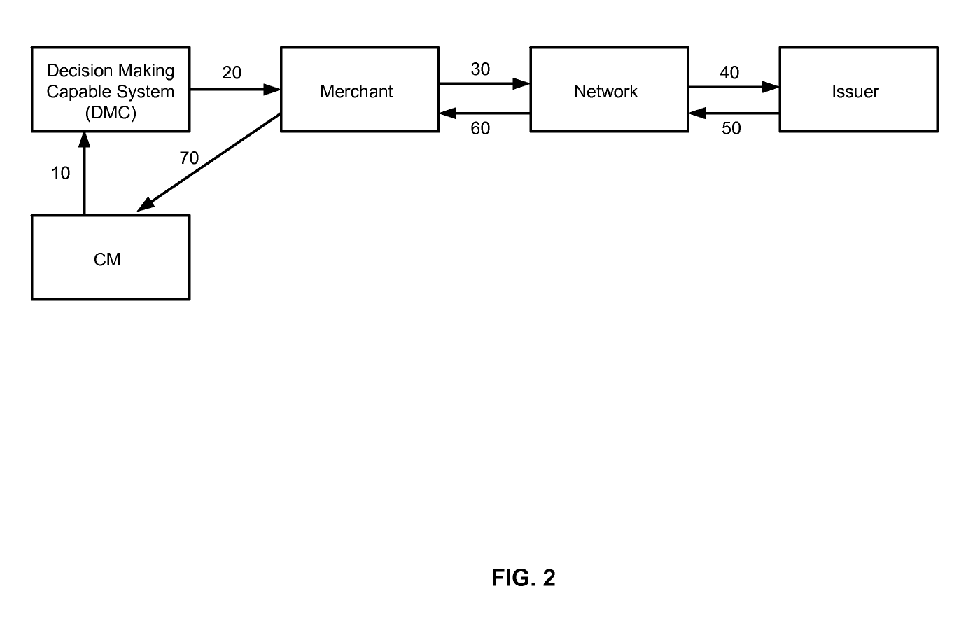

According to various embodiments and with reference to FIG. 2, in response to a transaction instrument holder securely logging into the e-wallet, an authentication process may occur and be associated with a transaction (Step 10). For instance, an American Express card may be selected by a user within the e-wallet. A traditionally used pre-stored shipping address may be selected. The e-wallet may run its normal processes to authenticate the transaction account holder. The transaction account issuer may determine, based on its capabilities, the method of authentication preferred with the transaction. The preferred method of authentication may be enacted. The transaction account issuer may receive the transaction details and the enhanced transaction details. The transaction account issuer may evaluate the transaction details and the enhanced transaction details. The transaction account issuer may approve the transaction. At this point, the e-wallet knows that the transaction instrument holder has successfully been authenticated via the preferred method of authentication. The e-wallet may electronically deliver to the merchant an appropriate smart token, based on the preferred method of authentication utilized, for use in the formal request for authorization and settlement (Step 20). The merchant may then submit its authorization request including the smart token (Step 30). On the backend, a request is made to the virtual vault to associate the smart token received with a stored smart token (Step 40). From this association, a PAN may be retrieved. The network may also identify the transaction as having a token and enact a token rules process. The issuer may make a decision to authorize or settle the transaction (Step 50). The network may respond to the merchant (Step 60). The merchant may display the transaction authorization result to the transaction instrument holder (Step 70).

At a future time, an audit may be performed where the type of authentication utilized in a transaction may be known solely from inspection of the token and virtual vault records. This method does not entail merchant system reconfiguration.

According to various embodiments, an individual dynamic token is requested and the information is associated on a one-time use case basis.

In various embodiments, the web-client may include and/or acquire (e.g., download as an application from an application provider) an application (e.g., software) that enables the web-client to acquire and/or read and/or decode the encoded secure token. If any portion of the application needed to acquire and/or decode the encoded secure token is not present on the web-client, the web-client may prompt the consumer to download, from an application provider (e.g., from the wallet platform) a software application suitable for such a purpose. Therefore, the application residing on the web-client may, as described herein, decode (as described herein or as is known in the art) the encoded data acquired from the web-client to retrieve the secure token.

In response to validating the secure token, the wallet platform may provide (encoded or decoded and/or encrypted and/or unencrypted) transaction account data (e.g., a transaction account number, an expiration date, a customer name, and the like) to the mobile communications device/web-client via the network and/or via a telecommunications network provided by a telecommunications provider. The transaction account data may be associated with the transaction account that was requested and approved “instantly” by the electronic acquisitions system (as described above). The mobile communications device/web-client may store the data, in response to receipt of the transaction account data.

In the detailed description herein, references to “one embodiment”, “an embodiment”, “an example embodiment”, “various embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in certain embodiments.

In various embodiments, the methods described herein are implemented using the various particular machines described herein. The methods described herein may be implemented using the particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., Windows NT, 95/98/2000, XP, Vista, OS2, UNIX, Linux, Solaris, MacOS, etc.) as well as various conventional support software and drivers typically associated with computers. A user may include any individual, business, entity, government organization, software and/or hardware that interact with a system.

In an embodiment, various components, modules, and/or engines of system 100 may be implemented as micro-applications or micro-apps. Micro-apps are typically deployed in the context of a mobile operating system, including for example, a Palm mobile operating system, a Windows mobile operating system, an Android Operating System, Apple iOS, a Blackberry operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available (e.g., Twofish, RSA, El Gamal, Schorr signature, DSA, PGP, PKI, and symmetric and asymmetric cryptosystems).

The computers discussed herein may provide a suitable website or other Internet-based graphical user interface which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system. In one embodiment, the Apache web server is used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), AJAX (Asynchronous Javascript And XML), helper applications, plug-ins, and the like. A server may include a web service that receives a request from a web server, the request including a URL (http://yahoo.com/stockquotes/ge) and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WebSphere MQ™ (formerly MQSeries) by IBM, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As used herein, the term “end user”, “consumer”, “customer”, “card member”, “business” or “merchant” may be used interchangeably with each other, and each shall mean any person, entity, machine, hardware, software or business. A bank may be part of the system, but the bank may represent other types of card issuing institutions, such as credit card companies, card sponsoring companies, or third party issuers under contract with financial institutions. It is further noted that other participants may be involved in some phases of the transaction, such as an intermediary settlement institution, but these participants are not shown.

Each participant is equipped with a computing device in order to interact with the system and facilitate online commerce transactions. The customer has a computing unit in the form of a personal computer, although other types of computing units may be used including laptops, notebooks, hand held computers, set-top boxes, cellular telephones, touch-tone telephones and the like. The merchant has a computing unit implemented in the form of a computer-server, although other implementations are contemplated by the system. The bank has a computing center shown as a main frame computer. However, the bank computing center may be implemented in other forms, such as a mini-computer, a PC server, a network of computers located in the same of different geographic locations, or the like. Moreover, the system contemplates the use, sale or distribution of any goods, services or information over any network having similar functionality described herein.

The merchant computer and the bank computer may be interconnected via a second network, referred to as a payment network. The payment network which may be part of certain transactions represents existing proprietary networks that presently accommodate transactions for credit cards, debit cards, and other types of financial/banking cards. The payment network is a closed network that is assumed to be secure from eavesdroppers. Exemplary transaction networks may include the American Express®, VisaNet® and the Veriphone® networks.

The electronic commerce system may be implemented at the customer and issuing bank. In an exemplary implementation, the electronic commerce system is implemented as computer software modules loaded onto the customer computer and the banking computing center. The merchant computer does not require any additional software to participate in the online commerce transactions supported by the online commerce system.

As will be appreciated by one of ordinary skill in the art, the system may be embodied as a customization of an existing system, an add-on product, upgraded software, a stand-alone system, a distributed system, a method, a data processing system, a device for data processing, and/or a computer program product. Accordingly, the system may take the form of an entirely software embodiment, an entirely hardware embodiment, or an embodiment combining aspects of both software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the inventions have been described as a method in certain embodiments, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method comprising:
receiving, by a computer-based system configured for processing token information, a selection of a transaction account code;
provisioning, by the computer-based system, a plurality of tokens per received transaction account code, wherein each token of the plurality of token is associated in a virtual vault according to a method of authentication to be used with the token; and
transmitting, by the computer-based system, the plurality of tokens to an e-wallet application.

2. The method of claim 1, further comprising encoding, by the computer-based system, the plurality of tokens.

3. The method of claim 1, wherein the method of authentication includes at least one of a one-time code, a 3-D Secure system, or an issuer authentication API.

4. The method of claim 1, wherein the method of authentication includes at least one of a finger print, a biometric, or a retinal scan.

5. The method of claim 1, further comprising processing, by the computer-based system, a transaction including the token.

6. The method of claim 1, further comprising shifting liability for fraud from a merchant to an issuer based on use of the method.

7. The method of claim 1, wherein the e-wallet stores the plurality of tokens for use based on the method of authentication available for a transaction.

8. The method of claim 1, wherein the method of authentication utilized in a transaction may be known from inspection of at least one the token or virtual vault records.

9. A system comprising:
a processor configured for processing token information;
a tangible, non-transitory memory configured to communicate with the processor, the tangible, non-transitory memory having instructions stored thereon that, in response to execution by the processor, cause the processor to perform operations comprising:
receiving, by the processor, a selection of a transaction account code;
provisioning, by the processor, a plurality of tokens per received transaction account code, wherein each token of the plurality of token is associated in a virtual vault according to a method of authentication to be used with the token; and
transmitting, by the processor, the plurality of tokens to an e-wallet application.

10. The system of claim 9, further comprising encoding, by the processor, the plurality of tokens.

11. The system of claim 9, wherein the method of authentication includes at least one of a one-time code, a 3-D Secure system, or an Issuer Authentication API.

12. The system of claim 9, wherein the method of authentication includes at least one of a finger print, a biometric, or a retinal scan.

13. The system of claim 9, further comprising processing, by the processor, a transaction including the token.

14. The system of claim 9, further comprising shifting liability for fraud from a merchant to an issuer based on use of the system.

15. The system of claim 9, wherein the e-wallet stores the plurality of tokens for use based on the method of authentication available for a transaction.

16. An article of manufacture including a non-transitory, tangible computer readable storage medium having instructions stored thereon that, in response to execution by a computer-based system configured for processing token information, cause the computer-based system to perform operations comprising:
receiving, by the computer-based system, a selection of a transaction account code;
provisioning, by the computer-based system, a plurality of tokens per received transaction account code, wherein each token of the plurality of token is associated in a virtual vault according to a method of authentication to be used with the token; and
transmitting, by the computer-based system, the plurality of tokens to an e-wallet application.

17. The article of manufacture of claim 16, further comprising encoding, by the computer-based system, the plurality of tokens.

18. The article of manufacture of claim 16, wherein the method of authentication includes at least one of a one-time code, a 3-D Secure system, or an issuer authentication API.

19. The article of manufacture of claim 16, wherein the method of authentication includes at least one of a finger print, a biometric, or a retinal scan.

20. The article of manufacture of claim 16, wherein the method of authentication utilized in a transaction may be known from inspection of at least one the token or virtual vault records.
